(19) United States
(12) Patent Application Publication
(10) Pub. No.: US 2005/0200906 A1
(43) Pub. Date: Sep. 15, 2005

(54) Facsimile machine, facsimile transmission instruction device and facsimile transmission method

(75) Inventor: Yoshifumi Tanimoto, Hirakata-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 11/076,061

(22) Filed: Mar. 10, 2005

(30) Foreign Application Priority Data
Mar. 10, 2004 (JP) 2004-067912

(51) Int. Cl. H04Q 11/00

(52) U.S. Cl. 358/400

(57) ABSTRACT

A Multi Function Peripheral includes a cover page template database which stores templates of a plurality of types of cover pages, a transmission data database which stores transmitted transmission data, and a transmission history information database which stores, in case a cover page is added at a transmission, template information that specifies a template of the added cover page and character information inserted in the added cover page, respectively as a transmission history, by associating to each of the transmission data stored in the transmission data database.

### BACKGROUND OF THE INVENTION

1. Field of the Invention

The present invention relates to a facsimile machine, and more particularly to a facsimile machine which can add a cover page to a transmission original document.

2. Description of Related Art

When carrying out a facsimile transmission, there are many cases in which a cover page including a destination (for example, a company name, a department name and a name of a recipient), a transmitter (for example, a company name, a department name and a name of a transmitter) and a title or the like is created separately and attached to a transmission original document. However, it is extremely troublesome to carry out an operation to separately create and print out a cover page, to attach the cover page to an uppermost sheet of an original document and to carry out a transmission, each time when carrying out a facsimile transmission. To eliminate such a troublesome operation, according to a proposed facsimile machine, when the above mentioned items to be included in a cover page are input by operating a keyboard or the like, a cover page is created automatically in the facsimile machine and transmitted.

Meanwhile, digital Multi Function Peripherals (MFPs) having multiple functions such as a copying function, a transmission function, a facsimile function and a printer function are recently becoming widespread. According to the copying function, an image printed on a printing paper is scanned to retrieve image data, and an image based on the retrieved image data is formed and output. According to the transmission function, the retrieved image data is transmitted to a remote device. According to the facsimile function, data is transmitted to and received from another facsimile machine by using a facsimile communication. According to the printer function, data obtained from a remote device via a communication line or the like is output.

Among such MFPs, one MFP stores in a storage unit, the image data retrieved by the MFP and the image data obtained from a remote device or the like. According to necessity, the MFP fetches the stored image data from the storage unit and carries out a facsimile transmission of the image data by the facsimile communication function. The MFP can also include a function as a file server. By using such an MFP having the function as the file server, a user can carry out a facsimile transmission again of an original document transmitted once by facsimile, to another transmission destination without scanning the original document again. Moreover, the user can combine a plurality of original documents or combine different original documents respectively transmitted once to a plurality of transmission destinations, as one original document and carry out a facsimile transmission.

In case the above-described cover page adding function is applied to the above-described MFP, under a state in which a cover page is attached to a transmission original document, the cover page and the original document are encoded into facsimile image data and the facsimile transmission is carried out. In addition, the data before being encoded into the facsimile image data is saved as a transmitted original document. Therefore, in case a transmission history is necessary to be saved, the MFP saves a plurality of original documents with the same content which only the cover page differs. Thus, substantially the same data is stored redundantly. This causes an increase in a data volume necessary to be stored by the MFP. As a result, a usage of the MFP is extremely inefficient.

### SUMMARY OF THE INVENTION

The present invention has been made in consideration of the above-described circumstances. An advantage of the present invention is to provide a facsimile machine which efficiently utilizes an MFP by saving data added with a cover page (transmission data) and processing and reusing only a part of the cover page of the transmission data, and which simplifies an operation when carrying out a facsimile transmission from the MFP.

According to a first aspect of the present invention, a facsimile machine transmits transmission data by a facsimile communication or by an electronic mail communication in which the transmission data is transmitted as an attached file of an electronic mail. The transmission data includes image information of a cover page in which character information is inserted in a template in which any character information can be inserted, and transmission image information. The facsimile machine includes a template storage unit, a transmission data storage unit and a transmission history storage unit. The template storage unit stores templates of a plurality of types of cover pages. The transmission data storage unit stores transmitted transmission data. The transmission history storage unit stores, in case a cover page is added at a transmission, template information that specifies a template of the added cover page and character information that is inserted in the added cover page, respectively as a transmission history, by associating to each of the transmission data stored in the transmission data storage unit.

According to the first aspect, the transmission data transmitted once by facsimile is stored directly. In addition, the template of the corresponding cover page and the character information that is inserted in the cover page are respectively associated with the transmission data and stored separately from the transmission data.

According to a second aspect of the present invention, the facsimile machine further includes a transmission data selecting unit, a template specifying unit, a template changing unit and an inserting unit. The transmission data selecting unit selects any one of the transmission data stored in the transmission data storage unit. The template specifying unit specifies a template of a cover page added to the selected transmission data in accordance with the template information stored in the transmission history storage unit by being associated with the transmission data selected by the transmission data selecting unit. The template changing unit changes the template specified by the template specifying unit into any one of the templates stored in the template storage unit. The inserting unit inserts into the template changed by the template changing unit, the character information stored in the transmission history storage unit by being associated with the transmission data selected by the transmission data selecting unit.

According to the second aspect, when any one of the stored transmission data is selected, in accordance with the template information stored by being associated with the selected transmission data, the template of the cover page added to the selected transmission data is specified. The specified template can be change into any one of the templates stored in the template storage unit. In case the template is changed, the character information stored by being associated with the selected transmission data is inserted into the changed template.

According to a third aspect of the present invention, the facsimile machine further includes a transmission data selecting unit, a template specifying unit and a changing unit. The transmission data selecting unit selects any one of the transmission data stored in the transmission data storage unit. The template specifying unit specifies a template of a cover page added to the selected transmission data in accordance with the template information stored in the transmission history storage unit by being associated with the transmission data selected by the transmission data selecting unit. The changing unit changes character information that is inserted in the template specified by the template specifying unit.

According to the third aspect, in case any one of the stored transmission data is selected, in accordance with the template information stored by being associated with the selected transmission data, the template of the cover page added to the selected transmission data is specified. Then, a change can be made to the character information that is inserted in the specified template.

According to a fourth aspect of the present invention, the facsimile machine further includes a transmission data selecting unit, a template specifying unit and a selecting unit. The transmission data selecting unit selects a plurality of any of the transmission data stored in the transmission data storage unit. The template specifying unit specifies templates of cover pages respectively added to the selected plurality of the transmission data in accordance with a plurality of the template information stored in the transmission history storage unit by being associated with the plurality of the transmission data selected by the transmission data selecting unit. The selecting unit selects whether to reuse any one of a plurality of templates specified by the template specifying unit or whether to use a template among the templates stored in the template storage unit that is different from the plurality of the templates specified by the template specifying unit.

According to the fourth aspect, in case a plurality of any of the stored transmission data is selected, in accordance with the template information stored by being associated with the selected plurality of transmission data, the templates of the plurality of the cover pages added to the selected plurality of transmission data are specified. Then, a selection can be made whether to reuse any one of the specified plurality of templates or whether to use a template that is different from the specified templates.

According to the first aspect, the transmission data that is transmitted once by facsimile is stored directly. Therefore, a storage capacity of the storage unit can be utilized efficiently. In addition, the template of the corresponding cover page and the character information that is inserted in the cover page are respectively associated with the transmission data and transmitted separately from the transmission data. Therefore, when reusing the transmission data, the template of the cover page and the character information can be changed easily.

According to the second aspect, in case any one of the stored transmission data is selected, the template of the cover page added to the selected transmission data is specified and the specified template can be changed to any one of the templates stored in the template storage unit. In addition, in case the template is changed, the character information stored by being associated with the selected transmission data is inserted into the changed template. Therefore, only the cover page can be changed.

According to the third aspect, in case any one of the stored transmission data is selected, in accordance with the template information stored by being associated with the selected transmission data, the template of the cover page is specified. Then, the character information that is inserted in the specified template can be changed. Therefore, character information of a destination or the like can be changed and the same cover page can be reused.

According to the fourth aspect, in case a plurality of any of the stored transmission data is selected, in accordance with a plurality of the template information stored by being associated with the selected plurality of transmission data, the templates of the plurality of the cover pages are specified. Then, a selection can be made whether to reuse any one of the specified plurality of templates or whether to use a template that is different from the specified templates. Therefore, one cover page can be added to a plurality of transmission data and reused.

### BRIEF DESCRIPTION OF THE SEVERAL VIEWS OF THE DRAWINGS

FIG. 1 is a schematic view showing an example of a network configuration including an MFP as a facsimile machine according to an embodiment of the present invention.

FIG. 2 is a block diagram showing an example of an inner configuration of the MFP as a facsimile machine according to an embodiment of the present invention.

FIG. 3 shows an initial screen for a facsimile transmission provided from the MFP as a facsimile machine according to an embodiment of the present invention.

FIG. 4 shows a display screen at a Personal Computer (PC) when a “cover page template” button is selected.

FIG. 5 shows an example of a template of a cover page.

FIG. 6 shows another example of a template of a cover page.

FIG. 7 shows an example of a registered content of a transmission history database of the MFP as a facsimile machine according to an embodiment of the present invention.

FIG. 8 shows a display screen at the PC when a “transmitted data” button is selected.

FIG. 9 shows a display screen at the PC when a “cover page template” button is selected.

FIG. 10 shows a display screen at the PC when a “transmitted data” button is selected.

FIG. 11 shows a display screen at the PC when a “cover page template” button is selected.

FIG. 12 is a flowchart showing a processing protocol of a facsimile transmission carried out by the MFP as a facsimile machine according to an embodiment of the present invention.

FIG. 13 is a flowchart showing a processing protocol of a facsimile transmission carried out by the MFP as a facsimile machine according to an embodiment of the present invention.

FIG. 14 is a flowchart showing a processing protocol of a facsimile transmission carried out by the MFP as a facsimile machine according to an embodiment of the present invention.

FIG. 15 is a flowchart showing a processing protocol of a facsimile transmission carried out by the MFP as a facsimile machine according to an embodiment of the present invention.

FIG. 16 is a flowchart showing a processing protocol of a facsimile transmission carried out by the MFP as a facsimile machine according to an embodiment of the present invention.

FIG. 17 is a flowchart showing a processing protocol of a facsimile transmission carried out by the MFP as a facsimile machine according to an embodiment of the present invention.

### DETAILED DESCRIPTION OF THE INVENTION

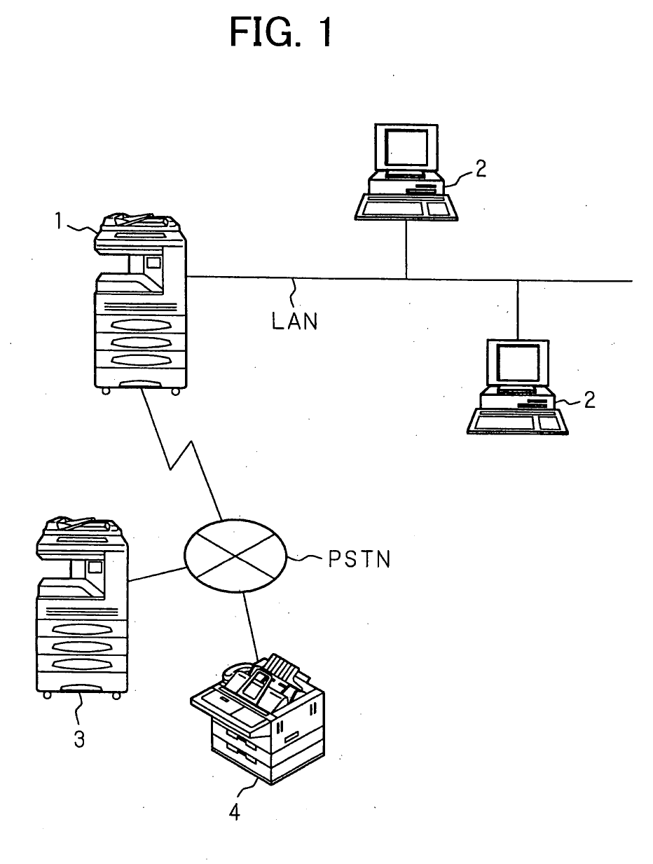

An MFP as a facsimile machine according to an embodiment of the present invention will be described with reference to the drawings. FIG. 1 is a schematic view showing an example of a network configuration including an MFP as a facsimile machine according to an embodiment of the present invention. In FIG. 1, a reference numeral 1 denotes an MFP as a facsimile machine according to an embodiment of the present invention.

The MFP 1 is connected to a plurality of PCs 2 and 2 via a Local Area Network (LAN). The MFP 1 is also connected to a remote MFP 3 and a facsimile machine 4 via a Public Switched Telephone Network (PSTN). Further, other than the PCs 2 and 2 shown in the drawing, a plurality of PCs are also connected to the LAN. Other than the MFP 3 and the facsimile machine 4 shown in the drawing, a plurality of MFPS and facsimile machines are also connected to the PSTN. Therefore, the MFP 1 can carry out a communication with the plurality of the PCs 2 and 2 via the LAN and with the other MFP 3 and the facsimile machine 4 via the PSTN.

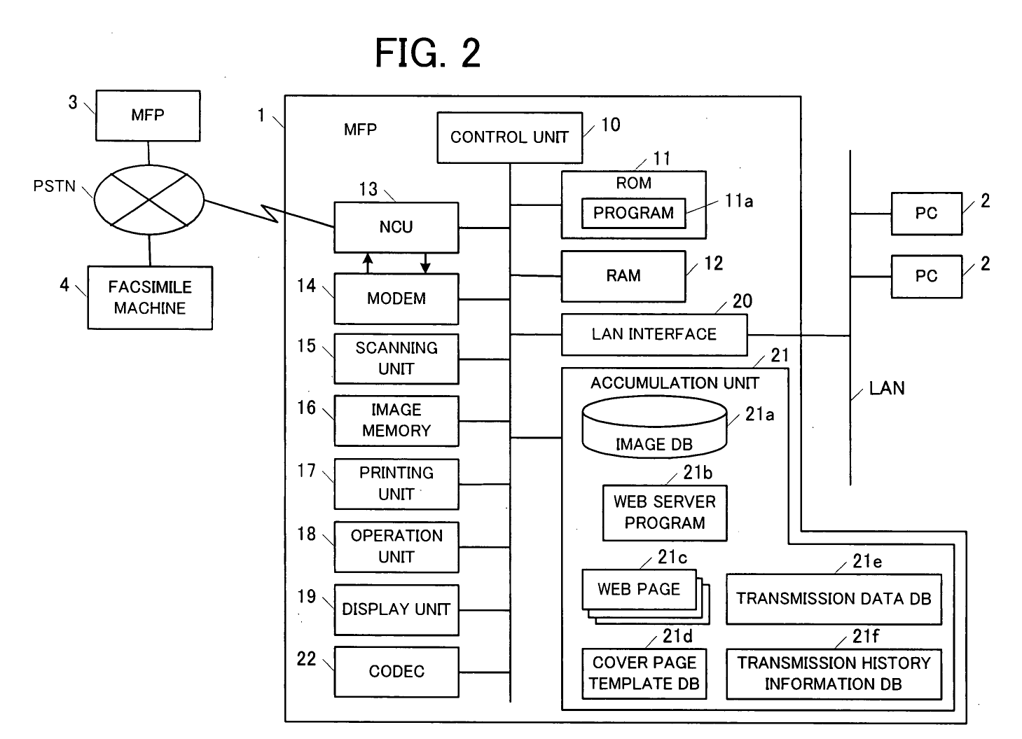

FIG. 2 is a block diagram showing an example of an inner configuration of the MFP 1 as the facsimile machine according to an embodiment of the present invention. The MFP 1 includes a control unit 10 formed of a Central Processing Unit (CPU) or a Micro Processor Unit (MPU) or the like. The control unit 10 is connected to a Read Only Memory (ROM) 11, a Random Access Memory (RAM) 12, a Network Control Unit (NCU) 13, a modem 14, a scanning unit 15, an image memory 16, a printing unit 17, an operation unit 18, a display unit 19, a LAN interface 20 for establishing a connection with the LAN, an accumulation unit 21 and a codec 22 for carrying out an encoding and a decoding process of image data, or the like via a bus.

The control unit 10 controls the above mentioned hardware components. In addition, the control unit 10 implements various software functions in accordance with a program 11a previously stored in the ROM 11. The program 11a includes, for example, various control programs necessary for an operation as the facsimile machine of the present invention, a program for carrying out a data communication with the PC 2 via the LAN interface 20 and a facsimile communication program for carrying out a facsimile communication with the remote MFP 3 and the facsimile machine 4 via the modem 14. The RAM 12 is composed of a Static RAM (SRAM) or a flash memory or the like. The RAM 12 temporarily stores data that is generated when a program is executed by the control unit 10.

The modem 14 is composed of a fax modem which can carry out a facsimile communication. The modem 14 is also connected directly to the NCU 13. The NCU 13 is connected to the PSTN. According to necessity, the NCU 13 connects the modem 14 to the PSTN to enable a facsimile communication to be carried out between the MFP 1 and the remote MFP 3 and the facsimile machine 4 via the PSTN.

The scanning unit 15 is composed of a scanner using a Charge Coupled Device (CCD). The scanning unit 15 obtains image data by scanning an original document and the obtained image data is stored into the image memory 16. The image memory 16 is composed of a Dynamic RAM (DRAM). The image memory 16 temporarily stores facsimile image data received by the facsimile communication via the modem 14 and the NCU 13 and the image data scanned by the scanning unit 15.

The printing unit 17 is an electrophotographic printer or the like. The printing unit 17 selects an appropriate sized printing paper or an Over Head Projector (OHP) sheet or the like from various sizes such as an A3 portrait, a B4 portrait, an A4 portrait, a B5 landscape and an A5 landscape. Then, the printing unit 17 prints out as a hardcopy, an image based on the image data stored in the image memory 16.

The operation unit 18 includes a ten-key numeric pad, a speed-dial key and various function keys or the like necessary for operating the MFP 1. The display unit 19 is a display such as a Liquid Crystal Display (LCD). For example, the display unit 19 displays an operational state of the MFP 1, a character input from the operation unit 18 and information to be notified to a user.

The MFP 1 having the above-described configuration functions as a following facsimile machine. That is, the MFP 1 scans by the scanning unit 15, an original document placed on a prescribed document table (not shown) by the user, to obtain image data. The MFP 1 temporarily stores the obtained image data once in the image memory 16. Then, the MFP 1 encodes the image data into facsimile image data by the codec 22. The MFP 1 transmits the facsimile image data via the NCU 13 and the modem 14 to the other MFP 3 and the facsimile machine 4 that are connected to the PSTN. Moreover, the MFP 1 receives via the PSTN, facsimile image data transmitted by the facsimile communication from the remote MFP 3 and the facsimile machine 4. The MFP 1 temporarily stores the received facsimile image data once in the image memory 16. Then, the MFP 1 decodes the facsimile image data into general image data in a format such as a bitmap, a Joint Photographic Experts Group (JPEG) and a Tagged Image File Format (TIFF) by the codec 22.

The MFP 1 also functions as a copying machine which copies onto a printing paper by the printing unit 17, an image based on the image data obtained by scanning an original document by the scanning unit 15. The MFP 1 also functions as a network printer which prints out onto a printing paper by the printing unit 17, an image based on the data received via the LAN interface 20 from the PCs 2 and 2 that are connected to the LAN. The MFP 1 also functions as a network scanner which transmits via the LAN interface 20 to the PCs 2 and 2 that are connected to the LAN, the image data obtained by scanning an original document by the scanning unit 15.

The MFP 1 includes the accumulation unit 21 formed of a nonvolatile storage device having a large storage capacity such as a hard disk and a flash memory. As described above, the image data received from a remote device by the facsimile communication and decoded by the codec 22, the image data scanned from an original document by the scanning unit 15 and the image data received via the LAN from the remote PCs 2 and 2 are stored appropriately as an image file in an image database (DB) 21a of the accumulation unit 21, and various processes are carried out simultaneously. Further, the MFP 1 also functions as a file server by accumulating the abovementioned various image data in the image DB (an image storage unit) 21a of the accumulation unit 21 as an image file to be reused by the user.

The MFP 1 stores a web server program 21b and a plurality of web pages 21c in the accumulation unit 21. The web server program 21b is a control program necessary for an operation as a web server. The web pages 21c are set with a link to the image file obtained by the above-described various functions and accumulated in the image DB 21b. The MFP1 also functions as a web server which provides the image file accumulated in the image DB 21a of the accumulation unit 21 from the web pages 21c to the PCs 2 and 2.

Therefore, in the PC 2 having a web browser, when a CPU (not shown) launches the web browser and designates the web page 21c provided from the MFP 1, the control unit 10 of the MFP 1 operates as a transmission unit for transmitting the image file accumulated in the image DB 21a of the accumulation unit 21 to the PC 2. Accordingly, a user of the PC2 can obtain a desired image file from the MFP 1 via the LAN to browse the image file or to carry out a desired process such as a facsimile transmission process.

Furthermore, in the accumulation unit 21, a cover page template DB 21d, a transmission data DB 21e and a transmission history information DB 21f or the like are set in an appropriate storage area. In the cover page template DB 21d, a template of a cover page added at a facsimile transmission is registered previously. The transmission data DB 21e accumulates transmission data transmitted by being encoded by the codec 22 at the facsimile transmission. In the transmission history information DB 21f, information other than the transmission data when each facsimile transmission is carried out is registered. In the transmission history information DB 21f, as the information other than the transmission data, transmission information and character information are registered by being associated with the transmission data. The transmission information is, for example, a destination, information indicating whether or not a cover page is added and information indicating which template is used in case a cover page is added. The character information is, for example, information inserted in a character input box of the template used when the cover page is added and the facsimile transmission is carried out.

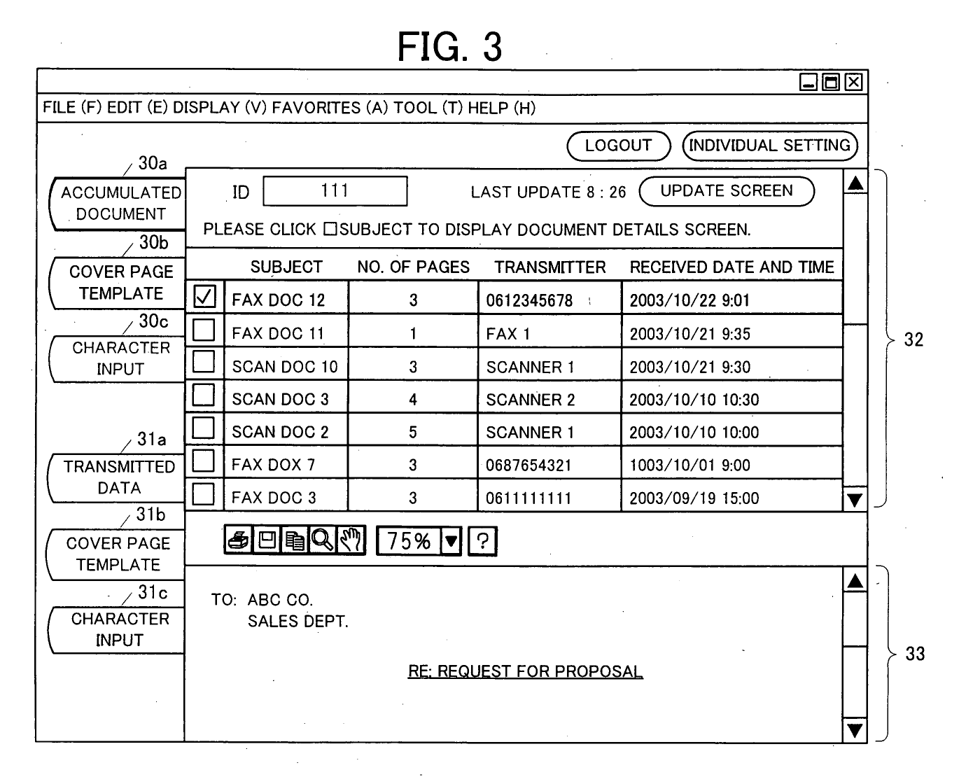

FIG. 3 shows an initial screen provided at the PC 2 where the web page 21c is provided from the MFP 1 via the LAN, when a page for a facsimile transmission is selected after the user logs in according to a login screen (not shown) . In the login screen, for example, an input of a user ID and a password or the like is requested.

The MFP 1 accumulates an image file obtained by various processes in the image DB 21a of the accumulation unit 21. As shown in FIG. 3, a screen displayed at the PC 2 displays an “accumulated document” button 30a, a “cover page template” button 30b and a “character input” button 30c or the like. The “accumulated document” button 30a is a selection button for browsing an image file accumulated in the image DB 21a. The “cover page template” button 30b is a button for selecting a template of a cover page. The “character input” button 30c is a button for inserting a character string into a character input box set in the template of the selected cover page. The buttons 30a through 30c are used when carrying out a facsimile transmission of an image file accumulated in the image DB 21a.

Other than the buttons 30a through 30c, the screen shown in FIG. 3 also displays a “transmitted data” button 31a, a “cover page template” button 31b and a “character input” button 31c or the like. The “transmitted data” button 31a is a selection button for browsing facsimile transmitted transmission data accumulated in the transmission data DB 21e. The facsimile transmitted transmission data is accumulated in the transmission data DB 21e under a state in which the transmission data is encoded into facsimile image data. The “cover page template” button 31b is a button for changing a template of a cover page. The “character input” button 31c is a button for changing a character inserted in a character input box set in a template of a cover page. A change of a character by the “character input” button 31c can be carried out regardless of whether or not a cover page is changed. The buttons 31a through 31c are used when carrying out a facsimile transmission by reusing the facsimile transmitted transmission data accumulated in the transmission data DB 21e.

Further, the initial screen for the facsimile transmission shown in FIG. 3 is a display screen when the “accumulated document” button 30a is selected. The initial screen shown in FIG. 3 displays the above-described buttons 30a through 30c and 31a through 31cand an image file list screen 32 displaying a file list of image data (an image file list) accumulated in the image DB 21a. Among image files accumulated in the image DB 21a, the image file list screen 32 displays a list of image files corresponding to a logged-in user. In other words, among the image files accumulated in the image DB 21a, the image file list screen 32 displays a list of image files which are permitted to be used by the logged-in user.

The image file list screen 32 displays file information of each image file such as a subject (a file name), a number of pages, a transmitter and a received date and time. By checking a check box displayed at a head of each file information, the user can receive a checked image file from the image DB 21a of the MFP 1 via the LAN. Accordingly, a desired image file can be browsed at the PC 2 and selected as an image file (a document) to be transmitted by facsimile. Further, in case of canceling the once selected image file and selecting another image file, after clearing the selection, a check box of the other image file can be selected. To clear the selection, the check box of the selected image file can be checked again. Moreover, by checking check boxes of a plurality of image files, a plurality of image files can be selected. In case a plurality of image files are selected, the selected plurality of image files can be collected into one and a facsimile transmission can be carried out.

In FIG. 3, the user of the PC 2 has selected an image file with a subject “FAX DOC 12”. In accordance with such a selection made by the user, the control unit 10 of the MFP 1 fetches a corresponding image file from the image DB 21a of the accumulation unit 21 and transmits the image file to the PC 2 via the LAN. Then, the PC 2 displays the image file received from the MFP 1 on an image display screen 33 located below the image file list screen 32. Accordingly, the user can browse and confirm at the PC 2, the image file to be transmitted by facsimile.

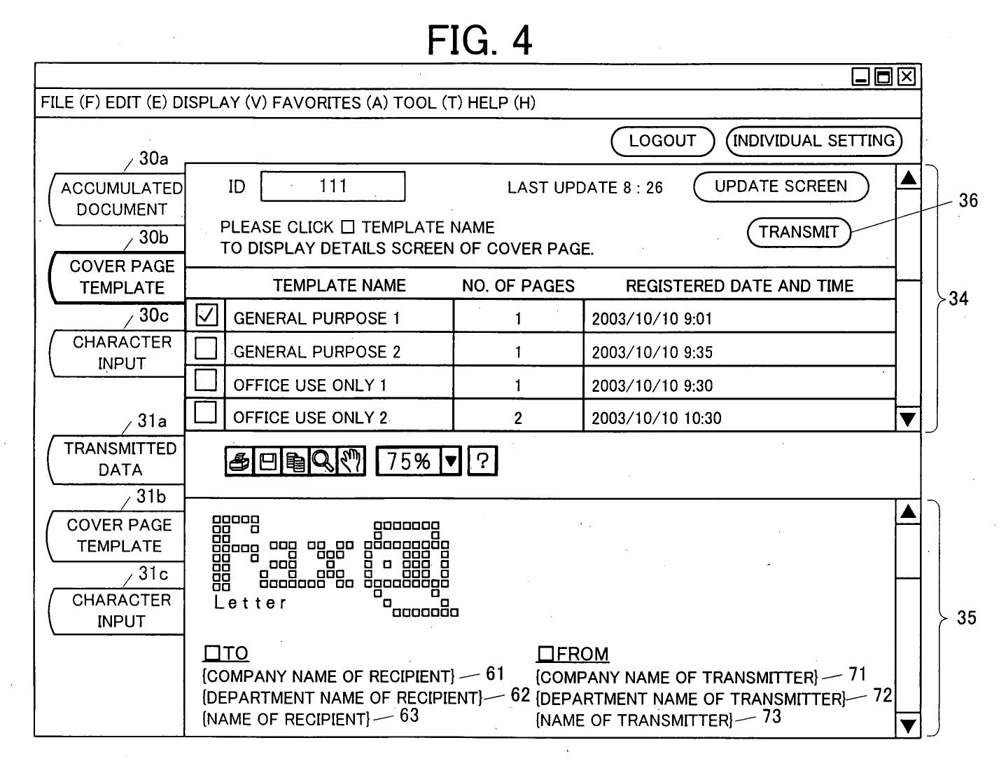

FIG. 4 shows a display screen at the PC 2 when the “cover page template” button 30b is selected. As shown in FIG. 4, a list of template names (a template list) is displayed on a template list screen 34. A template name is information that specifies a template of a cover page previously registered in the cover page template DB 21d. By checking a check box displayed at a head of each template name, the user selects a template. Consequently, the user can receive an image of the selected template, in other words, an image of a cover page, from the cover page template DB 21d of the MFP 1 via the LAN. Accordingly, a desired cover page can be browsed at the PC 2 and selected as a template of a cover page to be added to an image file (a document) to be transmitted by facsimile. Further, in case of canceling the once selected template and selecting another template, after clearing the selection, a check box of the other template can be checked. To clear the selection, the check box of the selected template can be checked again.

In the example shown in FIG. 4, the user of the PC2 has selected a template of “GENERAL PURPOSE 1”. In accordance with such a selection made by the user, the control unit 10 of the MFP 1 fetches image data of a corresponding template from the cover page template DB 21d of the accumulation unit 21 and transmits the fetched image data to the PC 2 via the LAN. Then, the PC 2 displays the image data of the template received from the MFP 1 on a cover page template display screen 35 located below the template list screen 34. Accordingly, the user can browse and confirm a cover page to be used for a facsimile transmission.

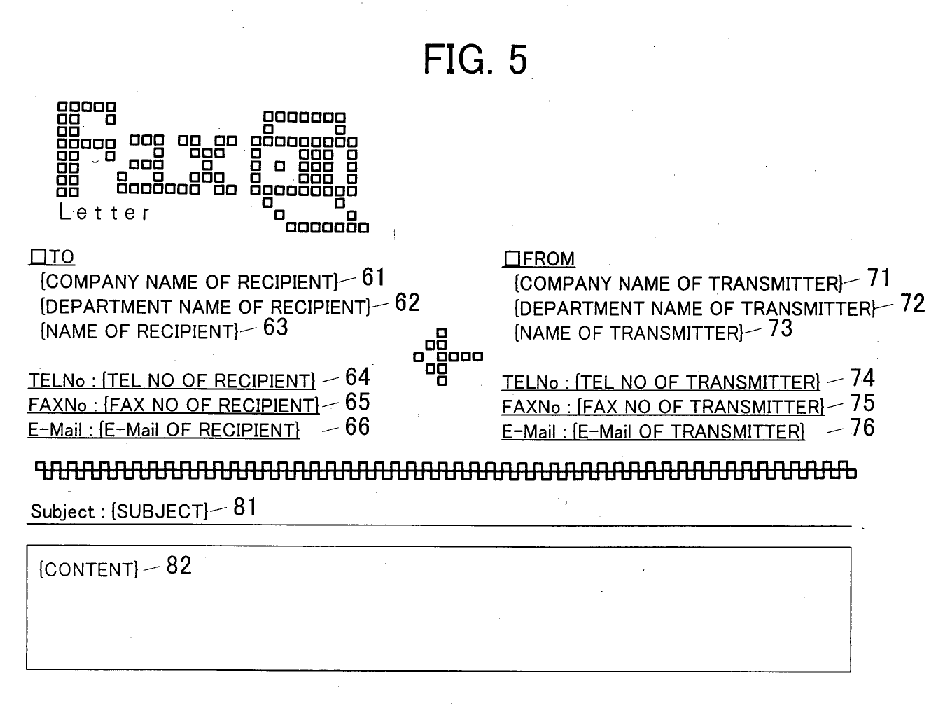

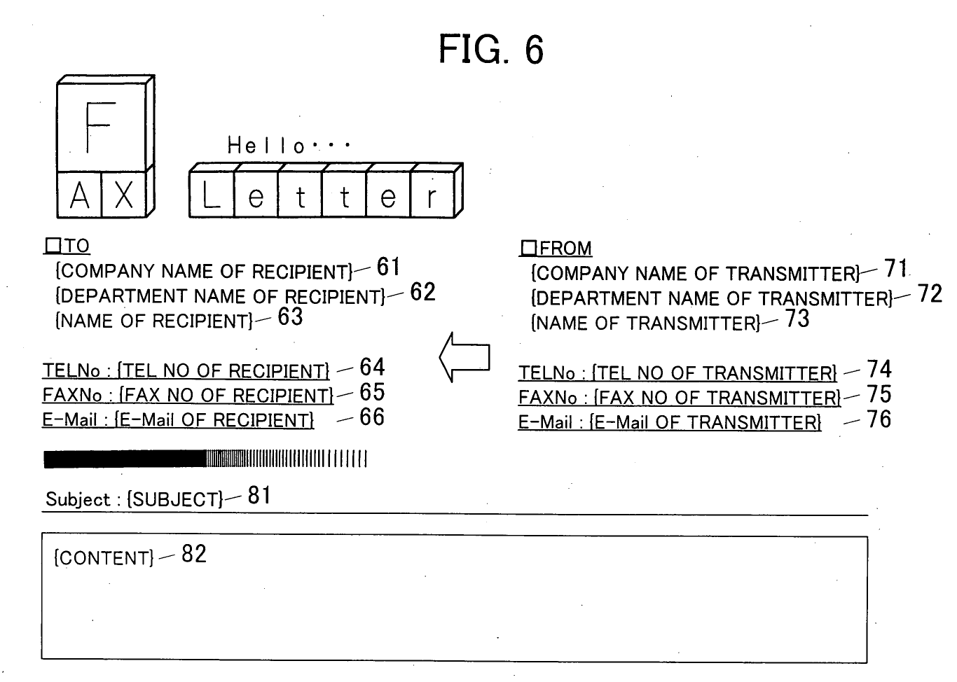

FIGS. 5 and 6 show examples of a template of a cover page. FIG. 5 shows an example of a template of the “GENERAL PURPOSE 1”. FIG. 6 shows an example of a template of a “GENERAL PURPOSE 2”. A plurality of such templates of cover pages are previously registered as image data in the cover page template DB 21d. A template of a cover page can be registered in the cover page template DB 21d under a state of data which can generate images as shown in FIGS. 5 and 6, instead of as image data.

When the “character input” button 30c is selected from the display screen of the PC 2 shown in FIG. 4, the user becomes capable of inserting any character string into character input boxes 61 through 66, 71 through 76, 81 and 82 in the template of the cover page. The character input boxes 61 through 66, 71 through 76, 81 and 82 are shown with “{ }” in the template of the cover page. From the cover page template display screen 35, the user can insert any character string into the character input boxes 61 through 66, 71 through 76, 81 and 82. For example, when the user clicks the character input box 61 of “{COMPANY NAME OF RECIPIENT}” with a mouse cursor, the clicked part is highlighted and the user becomes capable of inserting any character string (in this case, a company name of a destination or the like) by operating a keyboard.

Each character input box is set common in any of the templates. Therefore, by associating information that specifies each character input box of each of the templates with a character string inserted in each character input box and storing separately, a character string inserted in each character input box of a certain template can be inserted automatically into a corresponding character input box of another template in accordance with the information that specifies the character input box in which each character string is inserted.

Further, a plurality of character information to be input into the character input boxes can be registered previously and any one of the registered character information can be selected. Moreover, in the cover page template display screen 35 shown in FIG. 4, “{ }” indicating the character input boxes are displayed. However, at a recipient device in case the facsimile transmission is carried out actually as the cover page, “{ }” indicating the character input boxes are not displayed or printed.

In accordance with the screen of the PC 2 as shown in Fig. 4, the user of the PC 2 selects a desired image file and selects a template of a desired cover page. Then, the user of the PC 2 inserts a necessary character string into a character input box of the selected template of the cover page and selects a “transmit” button 36. Accordingly, the CPU of the PC 2 associates selected image data, information that specifies the selected template of the cover page and character information with one another and transmits to the MFP 1 via the LAN. The character information includes information that specifies each character input box of the selected template of the cover page and information of the character string inserted into each of the character input boxes from the cover page template display screen 35 of the PC 2.

Then, the control unit 10 of the MFP 1 executes a facsimile transmission. Specifically, the control unit 10 of the MFP 1 generates image data of the cover page selected by the user of the PC 2. The image data is temporarily stored in the image memory 16 as a first page. Each page of the image file selected by the user of the PC 2 is temporarily stored in the image memory 16 as a second page and onward. The image data and each page of the image file are transmitted to a previously set transmission destination by the facsimile communication function as a file of consecutive pages. The control unit 10 of the MFP 1 disposes the character string inserted by the user of the PC 2 into each character input box of the template of the cover page selected by the user of the PC 2 to generate image data of the cover page. In the facsimile transmission, the control unit 10 of the MFP 1 carries out a transmission while sequentially converting the image data of each page into facsimile image data by the codec 22.

In this case, the MFP 1 accumulates the transmission data in the transmission data DB 21e. In addition, the MFP 1 associates various pieces of transmission information added to the transmission data and the character information with one another and registers the transmission information and the character information in the transmission history information DB 21f. The transmission data is data encoded into facsimile image data for a facsimile transmission and data having the image data of the cover page as the first page. The transmission information includes information that specifies the template of the cover page added to the transmission data. The character information is information inserted in the character input box of the template of the cover page.

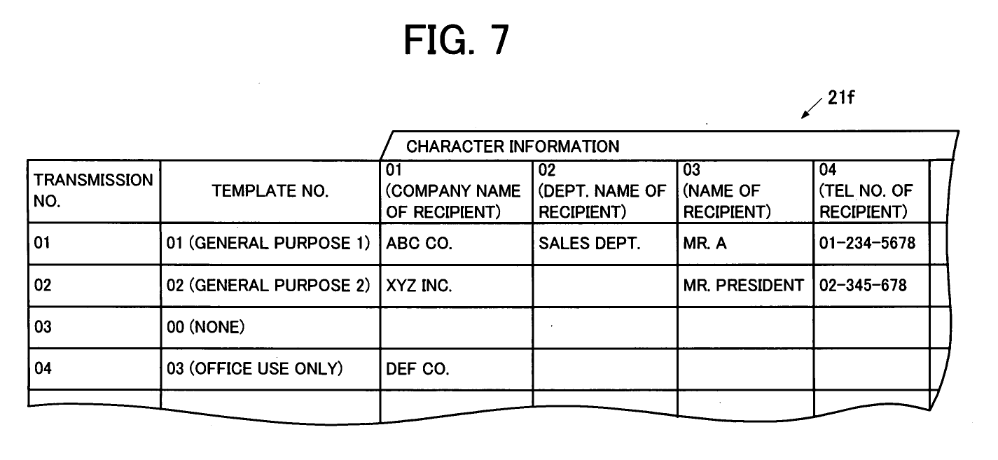

FIG. 7 shows an example of a registered content of the transmission history information DB 21f. In this example, for transmission data of “No. 1” registered in the transmission data DB 21e, “01 (GENERAL PURPOSE 1)” is registered as the information that specifies the template of the cover page (a template number). As the character information, for “01” which is information that specifies the character input box 61 of “{COMPANY NAME OF RECIPIENT}”, “ABC CO.” is registered. As the character information, for “02” which is information that specifies the character input box 62 of “{DEPT. NAME OF RECIPIENT}”, “SALES DEPT.” is registered. As the character information, for “03” which is information that specifies the character input box 63 of “{NAME OF RECIPIENT}”, “MR. A” is registered. As the character information, for “04” which is information that specifies the character input box 64 of “(TEL NO. OF RECIPIENT)”, “01-234-5678” is registered. Further, in case the template number is “00”, a template of a cover page is not used.

The above description has been made on a general facsimile communication. However, the Internet facsimile communication function using an electronic mail can also be used. In case of the Internet facsimile communication function, image data having image data of a cover page as a first page is transmitted as an attached file.

Meanwhile, as described above, the screens shown in FIGS. 3 and 4 display the buttons 31a, 31b and 31c or the like that are used when reusing the facsimile transmitted transmission data accumulated in the transmission data DB 21e. In the following, the buttons 31a, 31b and 31c or the like will be described.

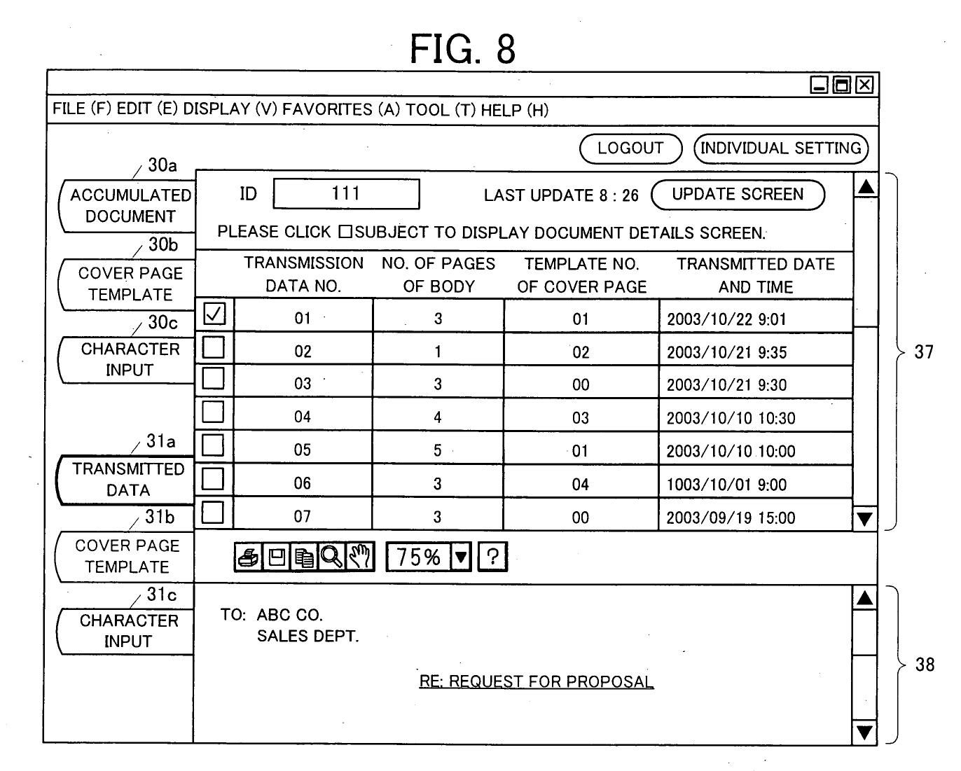

FIG. 8 shows a display screen at the PC 2 when the “transmitted data” button 31a is selected. The display screen shown in FIG. 8 displays a transmission data list screen 37 displaying a list of the transmission data accumulated in the transmission data DB 21e. Among the transmission data accumulated in the transmission data DB 21e, the transmission data list screen 37 displays a list of transmission data corresponding to a logged-in user ID. In other words, among the transmission data accumulated in the transmission data DB 21e, the transmission data list screen 37 displays a list of the transmission data which is permitted to be used by the logged-in user.

The transmission data list screen 37 displays a transmission data number and transmission history information. The transmission data number is information that specifies each transmission data accumulated in the transmission data DB 21e. The transmission history information is transmission history information corresponding to each transmission data. Specifically, the transmission history information includes a number of pages of a body excluding a cover page, a template number which is information that specifies a template of a cover page and a transmitted date and time, or the like. By checking a check box displayed at a head of each transmission data, the user can receive the checked transmission data from the transmission data DB 21e of the MFP 1 via the LAN and browse desired transmission data at the PC 2. In addition, the user can select desired transmission data as transmission data to be reused for a facsimile transmission. Further, in case of canceling the once selected transmission data and selecting another transmission data, after clearing the selection, a check box of another transmission data can be selected. To clear the selection, the check box of the already selected transmission data can be selected again. By selecting check boxes of a plurality of transmission data, the plurality of the transmission data can be transmitted by facsimile as one transmission data. In this case, a process becomes necessary so that the transmission data includes only one cover page. This process will be described later.

In FIG. 8, the user of the PC 2 has selected the transmission data which a transmission data number is “01”. In accordance with such a selection made by the user, the control unit 10 of the MFP 1 fetches the transmission data (the facsimile image data) of the corresponding number from the transmission data DB 21e of the accumulation unit 21. The control unit 10 of the MFP 1 decodes the facsimile image data into general image data and transmits the image data to the PC 2 via the LAN. The decoding process is carried out by the codec 22. The general image data is, for example, a bitmap, a JPEG or a TIFF format. The PC 2 displays the decoded transmission data received from the MFP 1 on a transmission data display screen 38 located below the transmission data list screen 37. Accordingly, the user can browse and confirm the transmission data to be reused for a facsimile transmission, in other words, the transmitted facsimile image data.

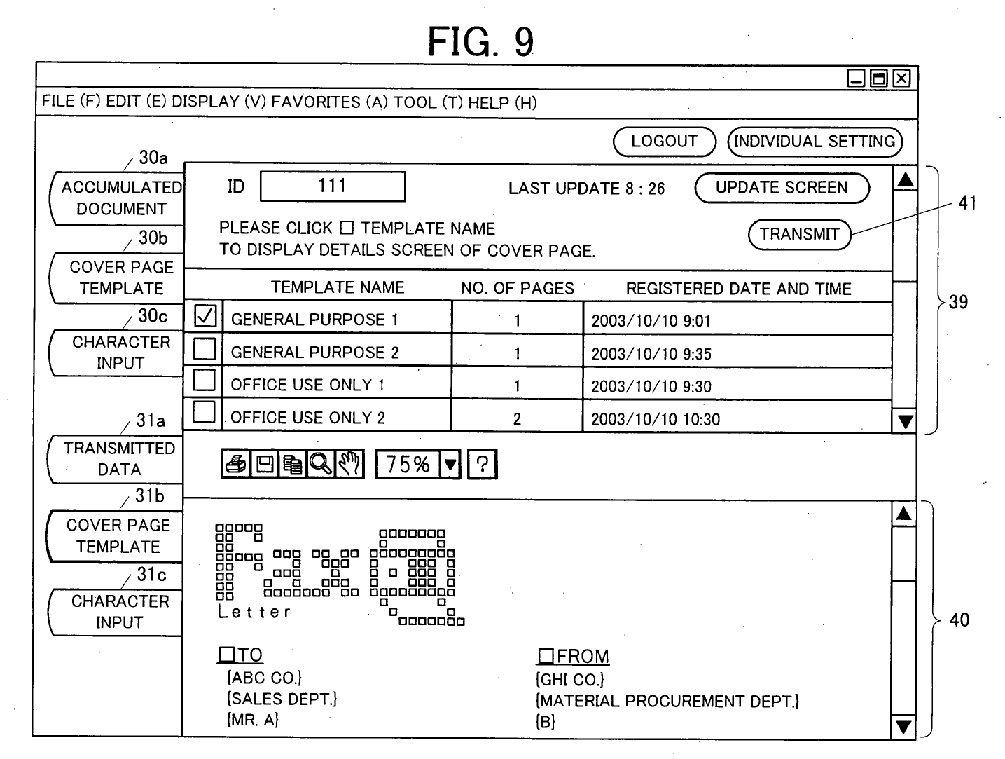

FIG. 9 shows a display screen at the PC 2 when the “cover page template” button 31b is selected from the screen shown in FIG. 8. As shown in FIG. 9, a transmitted template list screen 39 displays a list of template names of cover pages previously registered in the cover page template DB 21d. A transmitted template display screen 40 located below the transmitted template list screen 39 displays an image of the cover page added to the transmission data selected in FIG. 8. That is, the image of the cover page displayed on the transmitted template display screen 40 is an image generated by the MFP 1 in accordance with the template number and the character information registered in the transmission history information DB 21f by being associated with the transmission data selected from the screen shown in FIG. 8. At the same time, in response to the template of the cover page displayed on the transmitted template display screen 40, a check mark is displayed automatically in a check box of the list of the template names displayed on the transmitted template list screen 39.

In case the user wishes to reuse the cover page shown in FIG. 9 by adding the cover page directly to the transmission data shown in FIG. 8, the user can select a “transmit” button 41 shown in FIG. 9. However, in the general facsimile transmission, a reuse of the transmitted body and the cover page is assumed to be a simple retransmission. The simple retransmission is carried out, for example, when an initial transmission fails due to an accident or the like or when a recipient loses received data or a print out. Therefore, for many cases, any one of a changing process for changing the cover page, a changing process for changing the character string inserted in the cover page and a process for simultaneously carrying out both of the changing processes is required to be carried out.

First, a description will be made of a case in which the cover page is changed. In the screen shown in FIG. 9, by checking a check box of a template other than the check box with the check mark, a template corresponding to the newly checked check box is selected. In this case, the check of the check box that has been checked until this moment is cleared automatically. In other words, the body of the transmission data (a part other than the cover page) is reused, but the cover page can be changed to a cover page of another template. Further, in the example shown in FIG. 9, the template of the “GENERAL PURPOSE 1” is added to the transmission data selected by the user of the PC 2 from the screen shown in FIG. 8. In the screen shown in FIG. 9, when the check of the check box of the “GENERAL PURPOSE 1” is cleared and a check box of another template is checked, a template corresponding to the newly checked check box is displayed on the transmitted template display screen 40. In this case, in each character input box of the newly displayed template of the cover page, the character string inserted in each character input box of the previous template is displayed by being inserted directly into a corresponding character input box.

Next, a description will be made of a case in which a change is made to the character string inserted in the template. In the screen shown in FIG. 9, when the “character input” button 31c is selected, the character string inserted in each character input box of the template of the cover page display at that point of time on the transmitted template display screen 40 can be deleted or changed. Specifically, for example, in the template of the cover page of “GENERAL PURPOSE 1” displayed on the transmitted template display screen 40, when the user clicks a part of “ABC CO.” by a mouse cursor, the clicked part is highlighted. Under a state in which the part of “ABC CO.” is highlighted, by operating the keyboard, the user can input characters for another company name or the like in the part of “ABC CO.”. Further, the character information input in the character input boxes can be provided selectable from any one of a plurality of previously registered selections.

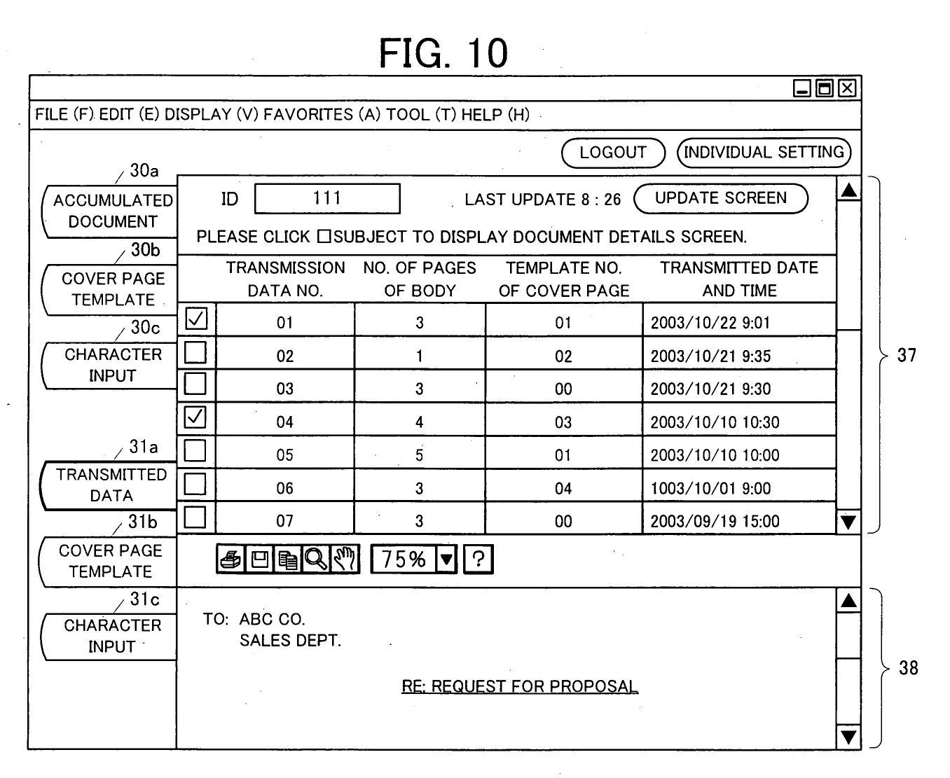

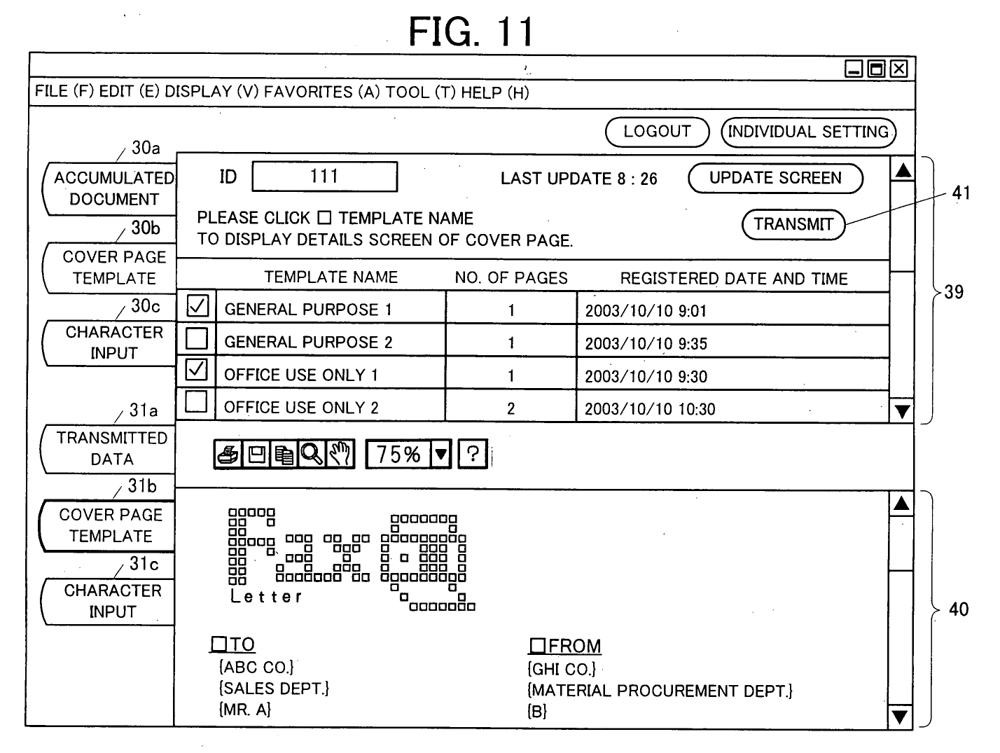

There are cases in which the user wishes to combine a plurality of already transmitted transmission data into one document and carry out a facsimile transmission. That is, there are cases in which the user wishes to combine a plurality of transmission data registered in the transmission data DB 21e into one document and carry out a facsimile transmission. In such a case, when check boxes of a plurality of necessary transmission data are checked on the transmission data list screen 37 as shown in FIG. 10 (in the example, the transmission data “01” and “04” are selected) and the “cover page template” button 31b is selected, a screen as shown in FIG. 11 is displayed at the PC 2. In the screen shown in FIG. 11, a plurality of check boxes are checked. The plurality of the check boxes are the template names of the cover pages respectively added to the plurality of the transmission data selected in the screen shown in FIG. 10. Specifically, in the screen shown in FIG. 11, check boxes of “GENERAL PURPOSE 1” and “OFFICE USE ONLY 1” are checked. The checked check boxes are the template names of the cover pages respectively added to the transmission data “01” and “04” selected in the screen shown in FIG. 10. Also in this case, in the same manner as described above, by checking again the check box of the template not to be used, the check of the template can be cleared. After clearing the check, by leaving only the check of the check box of the necessary template or by clearing all of the checks and checking a check box of a totally different template, a template of a cover page to be used actually can be selected.

By selecting the “character input” button 31c, the inserted character string can be changed or a new character string can be inserted in each character input box of the template in which the check of the check box is left without being canceled or a newly selected template.

As described above, in accordance with the screen of the PC 2 shown in FIG. 8 or FIG. 10, the user of the PC 2 can select the transmission data to be reused and select whether to use the template of the cover page added to the selected transmission data or to newly use a different template. After selecting the template of the cover page, the user of the PC 2 carries out an operation to change a character string inserted in a character input box of the selected template or to insert a new character string into a character input box of the selected template. Then, when the user of the PC 2 eventually selects the “transmit” button 41 shown in FIG. 9 or FIG. 11, the CPU of the PC 2 transmits to the MFP 1 via the LAN, information that specifies the selected transmission data, information that specifies the selected template of the cover page and information of the character string. The information of the character string is information of the character string inserted in the character input box of the selected template and information after a deletion or a change is made on the screen of the PC 2 by the user of the PC 2.

Then, the control unit 10 of the MFP 1 executes a facsimile transmission. Specifically, the control unit 10 of the MFP 1 generates image data of a cover page and temporarily stores the generated image data as a first page in the image memory 16. In this case, the control unit 10 of the MFP 1 generates the image data of the cover page by disposing the character string, inserted by the user of the PC 2, into each character input box of the template of the cover page selected by the user of the PC 2. Then, the control unit 10 of the MFP 1 temporarily stores the transmission data selected by the user of the PC 2 as a second page and onward in the image memory 16. The transmission data temporarily stored as the second page and onward is facsimile image data remaining after the facsimile image data of the cover page is deleted from the facsimile image data transmitted at a previous facsimile transmission. Then, the control unit 10 of the MFP 1 carries out a transmission to a previously set transmission destination by the facsimile communication function. In this case, the control unit 10 of the MFP 1 encodes only the cover page of the first page into facsimile image data by the codec 22 and carries out a transmission. The control unit 10 of the MFP 1 transmits the data of each page of the second page and onward directly.

Further, in case the user of the PC 2 selects a plurality of transmission data, the control unit 10 of the MFP 1 generates image data of a cover page and temporarily stores the generated image data in the image memory 16 as a first page. In this case, the control unit 10 of the MFP 1 generates the image data of the cover page by inputting the character string, inserted by the user of the PC 2, into each character input box of the template of the cover page selected by the user of the PC 2. Then, the control unit 10 of the MFP 1 temporarily stores the plurality of the transmission data selected by the user of the PC 2 in the image memory 16 as a second page and onward. The transmission data temporarily stored as the second page and onward is a combination of data of the facsimile image data remaining after the facsimile image data of each of the cover pages is deleted from each of the facsimile image data transmitted at a previous facsimile transmission. The control unit 10 of the MFP 1 carries out a transmission to a previously set transmission destination by the facsimile communication function. In this case, the control unit 10 of the MFP 1 encodes only the cover page of the first page into facsimile image data by the codec 22 and carries out a transmission. The control unit 10 of the MFP 1 transmits the data of each page of the second page and onward directly.

Further, in either case, the transmission data accumulated in the transmission data DB 21e is the facsimile image data encoded by the codec 22. Therefore, an encoding process by the codec 22 is unnecessary. Moreover, a data volume of the encoded facsimile image data is relatively small compared with a data volume of data before an encoding process. Therefore, a storage capacity of the transmission data DB 21e can be utilized efficiently.

Even in the case of the facsimile transmission reusing the transmission data as described above, in the MFP 1, the transmission data having the image data of the cover page as the first page is encoded into the facsimile image data for the facsimile transmission and accumulated in the transmission data DB 21e. In addition, various pieces of transmission information including the information that specifies the template of the cover page added to the transmission data accumulated in the transmission data DB 21e and the character information inserted in the character input box of the template of the cover page are associated with another and registered in the transmission history information DB 21f.

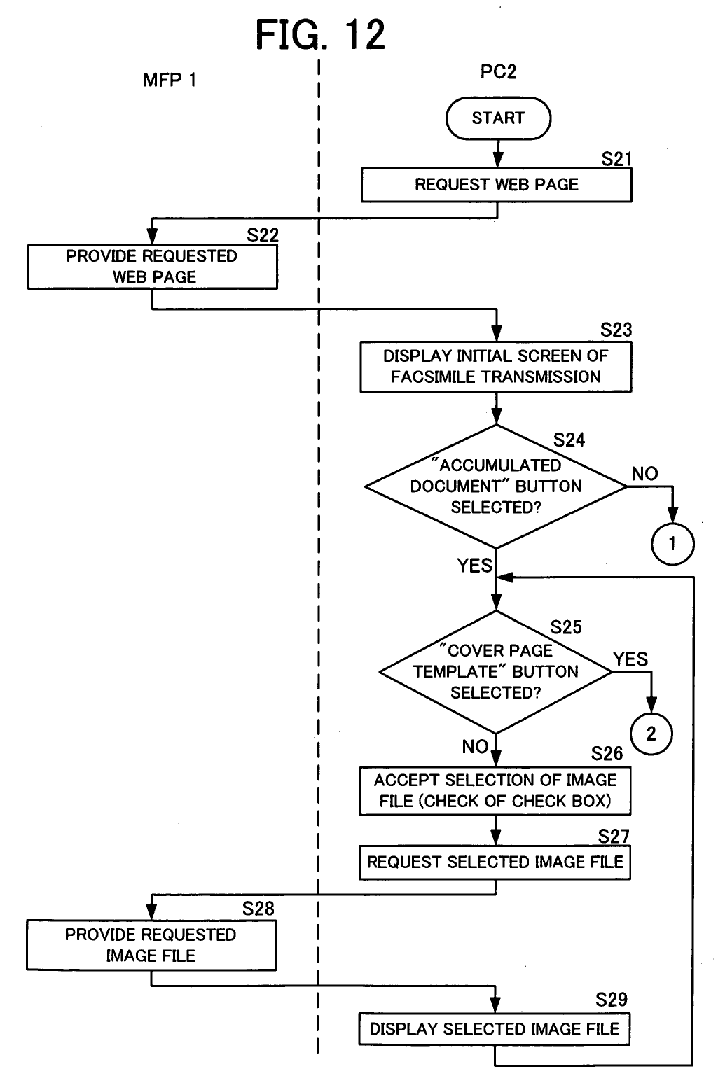

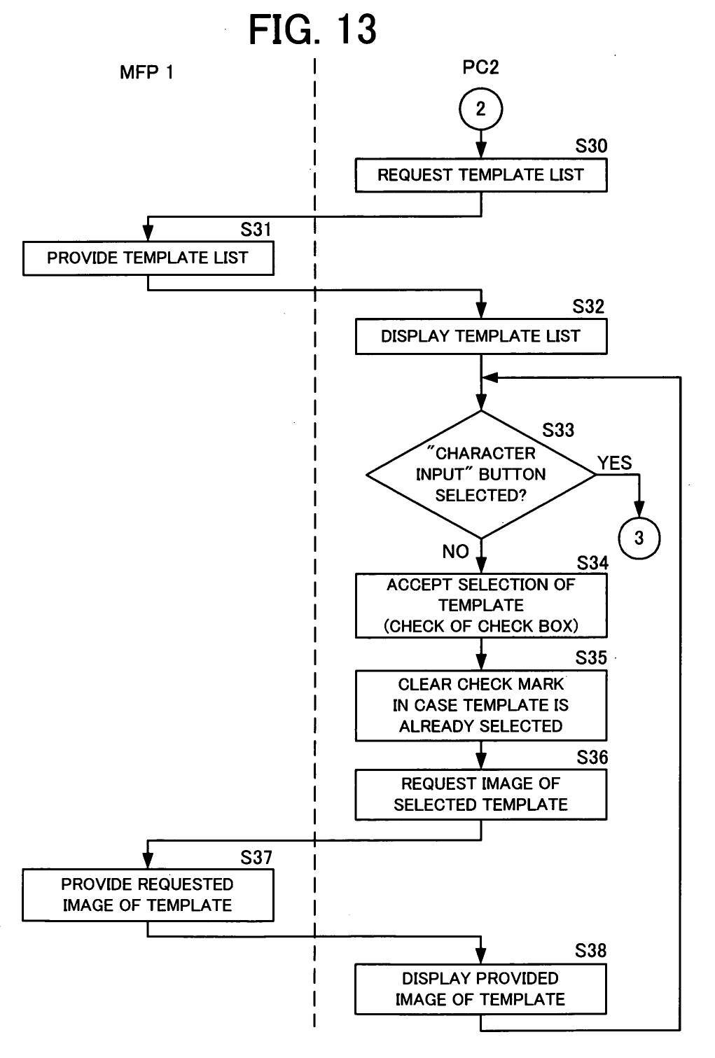

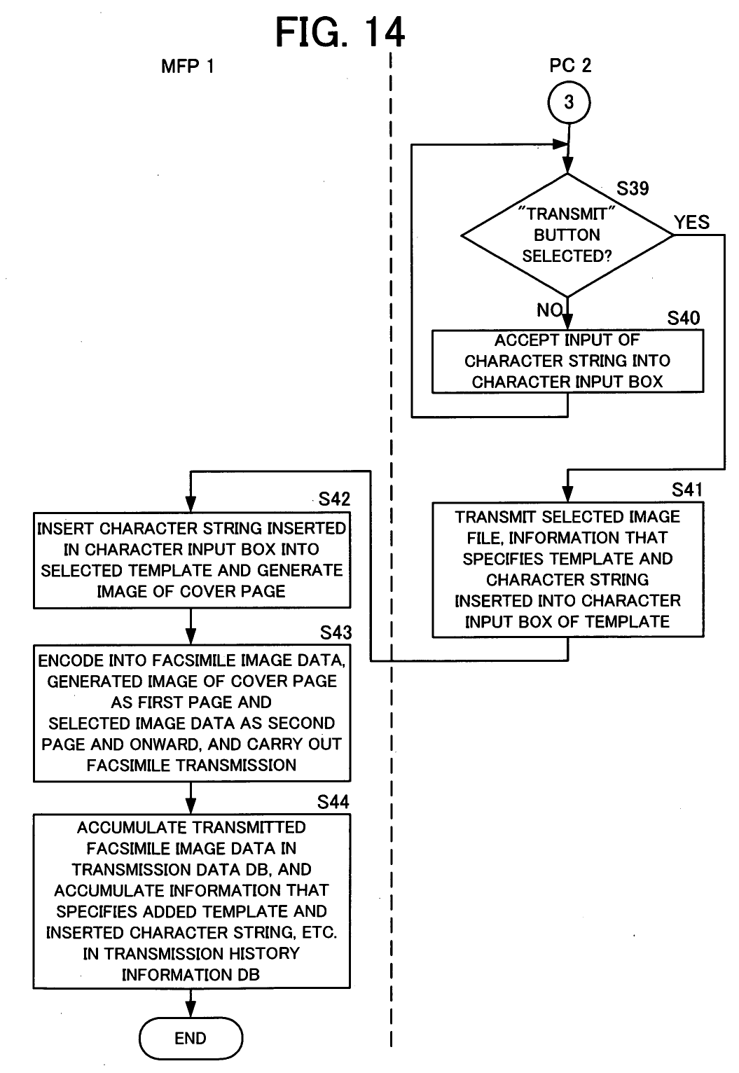

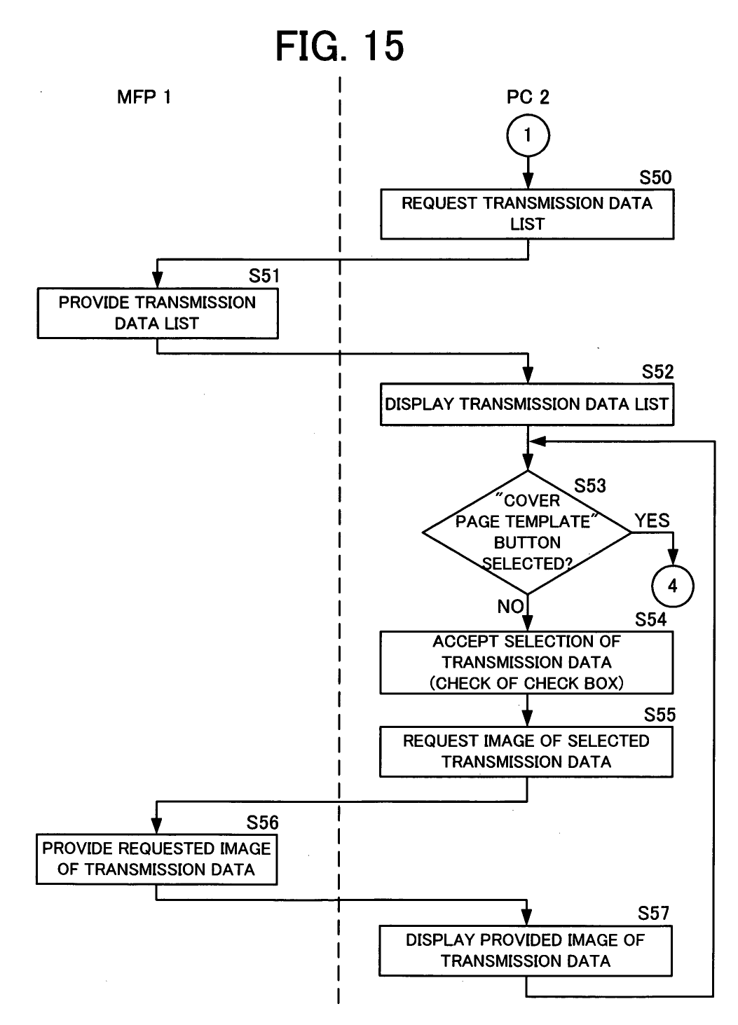

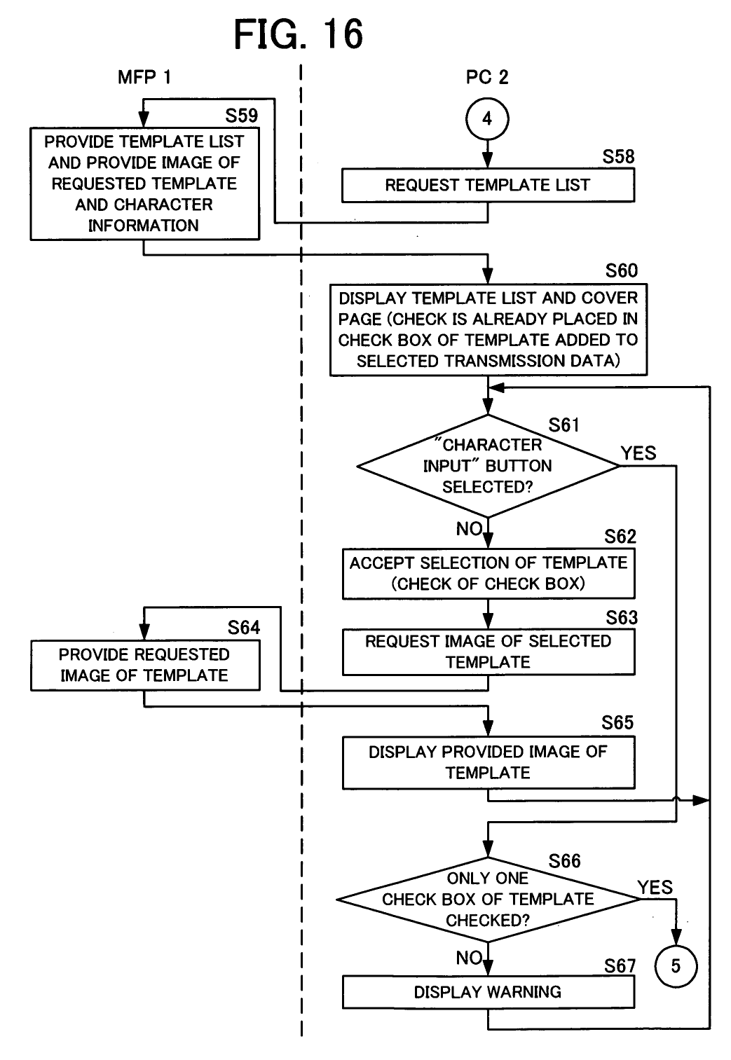

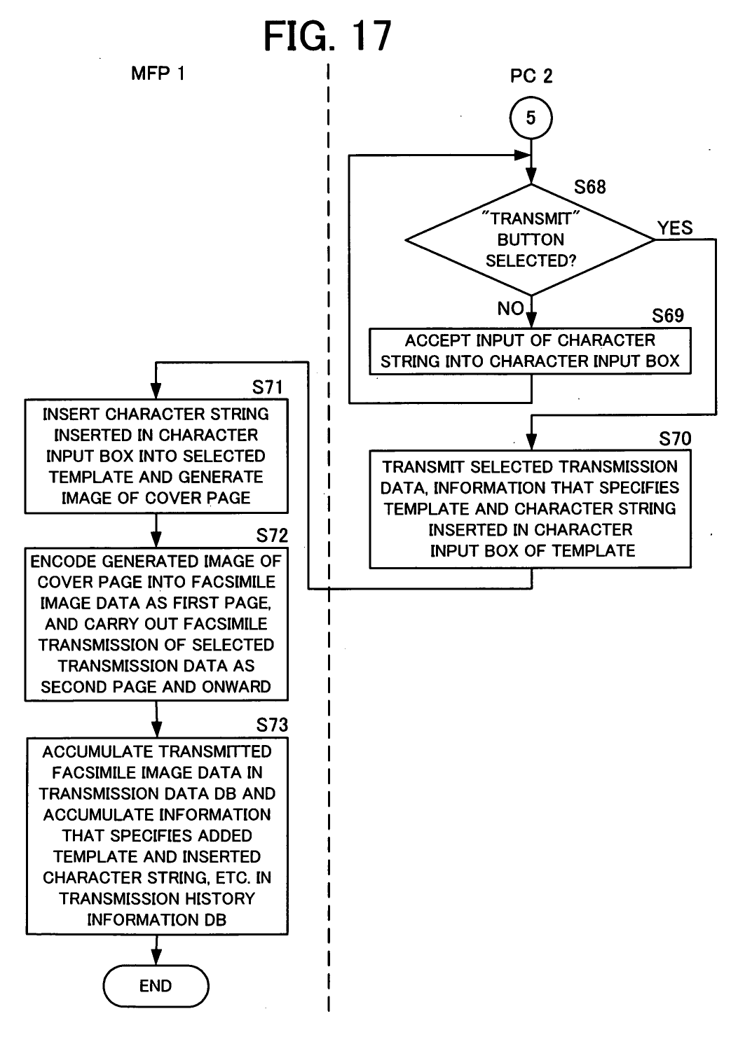

Referring to the flowcharts shown in FIG. 12 through FIG. 17, a description will be made of a processing protocol of the facsimile transmission carried out by the above-described MFP 1. Further, processes carried out at the facsimile transmission to be described below with reference to the flowcharts are executed by the control unit 10 of the MFP 1 in accordance with the program 11a stored previously in the ROM 11.

In case of carrying out a facsimile transmission of an image file stored in the image DB 21a of the accumulation unit 21 of the MFP 1, the user operates a prescribed operation unit (not shown) of the PC 2 to execute a web browser by the CPU of the PC 2. Accordingly, the CPU of the PC 2 requests a prescribed web page 21c from the MFP 1 (step S21).

The control unit 10 of the MFP 1 provides the web page 21caccording to the request of the PC 2 (step S22). The PC 2 displays the initial screen for the facsimile transmission as shown in FIG. 3 in accordance with the web page 21c obtained from the MFP 1 (step S23). In accordance with an instruction of the displayed initial screen, the user of the PC 2 selects the “accumulated document” button 30a or the “transmitted data” button 31a so as to select an image file or transmission data to be transmitted (step S24). In case of selecting an accumulated image file that has not been transmitted yet, the “accumulated document” button 30a can be selected. In case of selecting the already transmitted transmission data, the “transmitted data” button 31a can be selected. Further, the initial screen shows a display displayed when the “accumulated document” button 30a is selected.

In case the “accumulated document” button 30a is selected (YES at step S24), the image file list screen 32 as shown in FIG. 3 is displayed. Therefore, the user can check a check box of an image file to be transmitted by facsimile to select the image file to be transmitted by facsimile. The CPU of the PC2 accepts a selection of the image file made by the user as described above (step S26). Prior to step S26, the CPU of the PC 2 determines whether or not the “cover page template” button 30b has been selected (step S25). Until a determination is made that the “cover page template” button 30b has been selected (YES at step S25), the CPU of the PC 2 accepts a check of a check box of an image file made by the user. Accordingly, a plurality of image files can be accepted.

In case the selected image file is accepted at step S26, the CPU of the PC 2 requests the selected image file from the MFP 1 (step S27). The control unit 10 of the MFP 1 fetches the requested image file from the image DB 21a of the accumulation unit 21 and provides the image file to the PC 2 (step S28). The PC 2 displays the image file provided from the MFP 1 on the image display screen 33 as shown in FIG. 3 (step S29). The above-described processes are repeated until the “cover page template” button 30b is selected (until YES is selected at step S25). Accordingly, the PC 2 can select a plurality of image files.

In case the “cover page template” button 30b is selected (YES at step S25), the CPU of the PC 2 requests a template list from the MFP 1 (step S30). In response to the request, the MFP 1 provides to the PC 2, the template list which is the information that specifies the templates previously registered in the cover page template DB 21d (step S31). The PC 2 displays the template list on the template list screen 34 as shown in FIG. 4 (step S32).

As a result, the template list as shown in FIG. 4 is displayed on the template list screen 34. Therefore, the user can check a check box of a template of a cover page to be used for the facsimile transmission to select the cover page. The CPU of the PC 2 accepts a selection of the template of the cover page made by the user as described above (step S34). Prior to step S34, the CPU of the PC 2 determines whether or not the “character input” button 30c has been selected (step S33). Until a determination is made that the “character input” button 30c has been selected (until YES is selected at step S33), the CPU of the PC 2 accepts a selection of a template of a cover page made by the user.

When the CPU of the PC 2 accepts a selection of the template at step S34, in case of a presence of an already selected template (in case of a presence of a checked check box), the CPU of the PC 2 cancels the check of the check box of the already selected template (step S35). By this process, only one template of the cover page can be accepted. Under a state in which one template is selected, in case another template is selected newly, the selection of the previously selected template is canceled automatically.

The CPU of the PC 2 requests an image of the selected template from the MFP 1 (step S36). The MFP 1 fetches the requested image of the template from the cover page template DB 21d of the accumulation unit 21 and provides the image to the PC 2 (step S37). The PC 2 displays the image of the template of the cover page provided from the MFP 1 on the cover page template display screen 35 as shown in FIG. 4 (step S38).

In case the “character input” button 30c is selected (YES at step S33), the CPU of the PC 2 accepts an input of a character string into a character input box in the image of the cover page displayed on the cover page template display screen 35 (step S40). Prior to step S40, the CPU of the PC 2 determines whether or not the “transmit” button 36 has been selected (step S39). Until a determination is made that the “transmit” button 36 has been selected (until YES is selected at step S39), the CPU of the PC 2 accepts an input of a character into each character input box of the template of the cover page made by the user. Accordingly, an input of a character can be accepted for a plurality of character input boxes.

In case the “transmit” button 36 is selected (YES at step S39), the CPU of the PC 2 transmits to the MFP 1, the information that specifies the selected image file, the information that specifies the selected template and the information of the character string inserted in the character input box of the selected template (the character information) (step S41).

The MFP 1 receives the above information and the control unit 10 generates an image of the cover page (step S42). First, the control unit 10 fetches from the templates registered in the cover page template DB 21d, a template corresponding to the information that specifies the selected template. Then, the control unit 10 inserts the character information transmitted from the PC 2 into a character input box of the fetched template to generate the image of the cover page. Next, the control unit 10 of the MFP 1 temporarily stores the generated image of the cover page in the image memory 16 as the first page. Then, the control unit 10 fetches from the image files accumulated in the image DB 21a, an image file corresponding to the information that specifies the selected image file. The control unit 10 temporarily stores the fetched image file in the image memory 16 as the second page and onward. Next, the control unit 10 transmits the data temporarily stored in the image memory 16 while encoding the data into the facsimile image data by the codec 22 (step S43).

Then, the control unit 10 of the MFP 1 accumulates the transmitted facsimile image data in the transmission data DB 21e as the transmission data. In this case, the control unit 10 assigns information that specifies the transmission data (a transmission image data number) to the transmission data and accumulates the transmission data. Moreover, the control unit 10 associates the information that specifies the template of the cover page added to the transmission data and the character information inserted in the template with the transmission data. Each of the information associated with the transmission data is registered with the transmission history information DB 21f as the transmission history information (step S44).

Meanwhile, at step S24 of FIG. 12, in case the “transmitted data” button 31a is selected instead of the “accumulated document” button 30a (NO at step S24), the transmitted data (the transmission data), which is encoded into the facsimile image data and accumulated in the transmission data DB 21e, becomes capable of being reused.

At step S24, in case the “transmitted data” button 31a is selected instead of the “accumulated document” button 30a (NO at step S24), the CPU of the PC 2 requests a transmission data list from the MFP 1 (step S50). In response to the request, the control unit 10 of the MFP 1 provides to the PC 2, a list of the transmission data accumulated in the transmission data DB 21e (a transmission data list) (step S51) . The PC 2 displays the transmission data list on the transmission data list screen 37 as shown in FIG. 8 (step S52).

As a result, since the transmission data list as shown in FIG. 8 is displayed on the transmission data list screen 37 of the PC 2, the user can check a check box of transmission data to be reused for a facsimile transmission and select the transmission data to be reused. The CPU of the PC 2 accepts a selection of the transmission data made by the user as described above (step S54). Prior to step S54, the CPU of the PC 2 determines whether or not the “cover page template” button 31b has been selected (step S53). Until a determination is made that the “cover page template” button 31b has been selected (until YES is selected at step S53), the CPU of the PC 2 accepts a check of a check box of transmission data made by the user. Accordingly, a plurality of transmission data can be accepted.

When the CPU of the PC 2 accepts the selected transmission data at step S54, the CPU of the PC 2 requests the selected transmission data from the MFP 1 (step S55). The control unit 10 of the MFP 1 fetches the requested transmission data from the transmission data DB 21e of the accumulation unit 21 and provides the transmission data to the PC 2 (step S56). The PC 2 displays the transmission data provided from the MFP 1 on the transmission data display screen 38 as shown in FIG. 8 (step S57). The above-described processes are repeated until the “cover page template” button 31b is selected (until YES is selected at step S53). Accordingly, the PC 2 can select a plurality of transmission data.

In case the “cover page template” button 31b is selected (YES at step S53), the CPU of the PC 2 requests a template list from the MFP 1 and requests an image of the template and the character information added to the selected transmission data (step S58). In response to the request, the MFP 1 provides to the PC 2, the template list which is the information that specifies the template previously registered in the cover page template DB 21d. In addition, the MFP 1 provides to the PC 2, the image of the template and the character information requested by the PC 2 (step S59). The PC 2 displays the template list on the transmitted template list screen 39 as shown in FIG. 9. In addition, the PC 2 generates an image of the cover page from the image of the template and the character information provided from the MFP 1. The PC 2 displays the generated image of the template on the transmitted template display screen 40 (step S60). In this case, in the transmitted template list screen 39, a check mark is automatically added to a check box of a template name of the cover page added to the previously selected transmission data.

As a result, since the template list as shown in FIG. 9 is displayed on the transmitted template list screen 39, the user can check a check box of a template of a cover page to be used in the facsimile transmission for transmitting the previously selected transmission data and select the cover page. The CPU of the PC 2 accepts a selection of the template of the cover page made by the user as described above (step S62). Prior to step S62, the CPU of the PC 2 determines whether or not the “character input” button 31c has been selected (step S61). Until a determination is made that the “character input” button 31c has been selected (until YES is selected at step S61), the CPU of the PC 2 accepts a check of a check box of a template of a cover page made by the user.

At a point of time when the template list is displayed on the transmitted template list screen 39, a check is automatically added to the check box of the template added to the previously selected transmission data. Therefore, without checking a check box of another template, the “character input” button 31c can be selected directly (YES at step S61). In this case, the template added to the previously selected transmission data is used again directly.

Further, only one template of the cover page can be accepted. Under a state in which one template is selected, in case another template is selected newly, the selection of the previously selected template is canceled automatically. In case a plurality of transmission data have been selected, in the transmitted template list screen 39, check marks are added to the check boxes of the templates added to respective transmission data. In this case, a warning is generated as to be described later.

When the CPU of the PC 2 accepts the selected template at step S62, the CPU of the PC 2 requests an image of the selected template from the MFP 1 (step S63). The MFP 1 fetches the image of the template requested by the PC 2 from the templates previously registered in the accumulation unit 21 and provides the image of the template to the PC 2 (step S64). The PC 2 displays the image of the template of the cover page provided from the MFP 1 on the transmitted template display screen 40 as shown in FIG. 9 (step S65).

In case the “character input” button 31c is selected (YES at step S61), the CPU of the PC 2 confirms that only one check exists in the check boxes of the template list displayed on the transmitted template list screen 39 (YES at step S66). In case two or more checks exist in the check boxes of the template (NO at step S66), the CPU of the PC 2 carries out an appropriate warning (step S67). As the warning, for example, a message “Only one template can be selected for cover page” is displayed. Then, the process returns to step S61. Accordingly, the user of the PC 2 can understand that the checks in the check boxes of the transmitted template display screen 40 are necessary to be reduced so that only one check box is checked. Therefore, by repeating the processes of steps S62 through S65, the user of the PC 2 can carry out an operation to reduce the checks in the check boxes of the transmitted template display screen 40 so that only one check box is checked.

Meanwhile, at step S66, when a confirmation is made that only one check box is checked in the template list (YES at step S66), the CPU of the PC 2 accepts an input of a character string into a character input box of the image of the cover page (step S69). Prior to step S69, the CPU of the PC 2 determines whether or not the “transmit” button 41 has been selected (step S68). Until a determination is made that the “transmit” button 41 has been selected (until YES is selected at step S68), the CPU of the PC 2 accepts an input of a character into each character input box of the template of the cover page made by the user. Accordingly, the CPU of the PC 2 can accept an input of a character into a plurality of character input boxes.

Then, in case the “transmit” button 41 is selected (YES at step S68), the CPU of the PC 2 transmits to the MFP 1, the information that specifies the selected transmission data, the information that specifies the selected template and the information of the character string inserted in the character input box of the selected template (the character information) (step S70).

The MFP 1 receives the abovementioned information and the control unit 10 generates an image of the cover page (step S71). In this case, the control unit 10 fetches a template corresponding to the information that specifies the selected template from the templates registered in the cover page template DB 21d. The control unit 10 inserts the character information transmitted from the PC 2 into a character input box of the fetched template to generate the image of the cover page. Then, the control unit 10 of the MFP 1 carries out a facsimile transmission of the generated image of the cover page along with the transmission data fetched from the image DB 21a as new transmission data (step S72). In this case, the control unit 10 temporarily stores the generated image of the cover page in the image memory 16 and encodes the image into facsimile image data by the codec 22. The control unit 10 carries out a facsimile transmission of the facsimile image data along with the selected transmission data. In the transmission data to be transmitted by facsimile, the facsimile image data of the cover page is the first page and the selected transmission data is the second page and onward. Further, as described above, the transmission data is accumulated in the image DB 21a under a state in which the transmission data is encoded into the facsimile image data. Therefore, without encoding the transmission data into the facsimile image data again, the facsimile transmission can be carried out.

Further, in this case, when a plurality of transmission data is selected at the PC 2, the first page of each of the transmission data is the cover page. Therefore, only the second page and onward of each of the transmission data are combined as a second page and onward of new transmission data.

Subsequently, the control unit 10 of the MFP 1 accumulates the transmitted facsimile image data in the transmission data DB 21e as the transmission data. In this case, the control unit 10 assigns information that specifies the transmission data (a transmission image data number) to the transmission data and accumulates the transmission data. Moreover, the control unit 10 associates the information that specifies the template of the cover page added to the transmission data and the character information inserted in the template with the transmission data. Each of the information associated with the transmission data is registered with the transmission history information DB 21f as the transmission history information (step S73).

As described above, according to the facsimile machine of an embodiment of the present invention, the transmission data that is transmitted once by facsimile is stored directly. Therefore, a storage capacity of a storage unit can be utilized efficiently. Moreover, the template of the corresponding cover page and the character information inserted in the cover page are respectively associated with the transmission data and stored separately from the transmission data. As a result, when reusing the transmission data, the template of the corresponding cover page and the character information inserted in the cover page can be changed easily.

According to the facsimile machine of an embodiment of the present invention, when any one of the stored transmission data is selected, the template of the cover page added to the selected transmission data is specified. The specified template can be changed to any one of the templates stored in a template storage unit. In addition, when the template is changed, the character information stored by being associated with the selected transmission data is inserted into the image of the cover page generated by the changed template. Therefore, only the cover page can be changed.

According to the facsimile machine of an embodiment of the present invention, when any one of the stored transmission data is selected, the template of the cover page is specified in accordance with the template information stored by being associated with the selected transmission data. The character information inserted in the image of the cover page generated by the specified template can be changed. Therefore, for example, just by changing the character information of a destination or the like, the same cover page can be reused easily.

According to the facsimile machine of an embodiment of the present invention, when a plurality of any of the stored transmission data is selected, the templates of the plurality of the cover pages are specified in accordance with the template information stored by being associated with the selected plurality of the transmission data. A selection can be made whether to reuse any one of the specified plurality of the templates or whether to use a different template. Therefore, one cover page can be added to a plurality of transmission data and reused.

1. A facsimile machine, comprising:
a template storing means for storing templates of a plurality of types of cover pages;
a transmission data storing means for storing transmitted transmission data;
a transmission history storing means for storing template information that specifies a template of an added cover page and character information inserted in the added cover page, as a transmission history, by associating to each of the transmission data stored in the transmission data storing means; and
a transmitting means for transmitting image information of a cover page, in which character information is inserted in a template, and transmission image information as one transmission data.

2. The facsimile machine according to claim 1, wherein the transmitting means transmits the transmission data by a facsimile communication.

3. The facsimile machine according to claim 1, wherein the transmitting means transmits the transmission data as an attached file of an electronic mail by an electronic mail communication.

4. The facsimile machine according to claim 1, further comprising:
a transmission data selecting means for selecting any one of the transmission data stored in the transmission data storing means;
a template specifying means for specifying, in accordance with the template information stored in the transmission history storing means by being associated with the transmission data selected by the transmission data selecting means, a template of a cover page added to the selected transmission data;
a template changing means for changing the template specified by the template specifying means to any one of the templates stored in the template storing means; and
means for inserting into the template changed by the template changing means, the character information stored in the transmission history storing means by being associated with the transmission data selected by the transmission data selecting means.

5. The facsimile machine according to claim 4, wherein the transmission data selecting means includes means for inputting a request of a transmission data list, and means for outputting a list of the transmission data stored in the transmission data storing means when the request of the transmission data list is input.

6. The facsimile machine according to claim 4, wherein the template changing means includes means for inputting a request of a template list, and means for outputting a list of the templates stored in the template storing means when the request of the template list is input.

7. The facsimile machine according to claim 1, further comprising:
a transmission data selecting means for selecting any one of the transmission data stored in the transmission data storing means;
a template specifying means for specifying, in accordance with the template information stored in the transmission history storing means by being associated with the transmission data selected by the transmission data selecting means, a template of a cover page added to the selected transmission data; and
means for changing character information inserted in the template specified by the template specifying means.

8. The facsimile machine according to claim 7, wherein the transmission data selecting means includes means for inputting a request of a transmission data list, and means for outputting a list of the transmission data stored in the transmission data storing means when the request of the transmission data list is input.

9. The facsimile machine according to claim 1, further comprising:
a transmission data selecting means for selecting a plurality of any of the transmission data stored in the transmission data storing means;
a template specifying means for specifying, in accordance with a plurality of the template information stored in the transmission history storing means by being associated with the plurality of the transmission data selected by the transmission data selecting means, templates of cover pages respectively added to the selected plurality of the transmission data; and
means for selecting whether to reuse any one of the plurality of the templates specified by the template specifying means or whether to use a template among the templates stored in the template storing means that is different from the plurality of the templates specified by the template specifying means.

10. The facsimile machine according to claim 9, wherein the transmission data selecting means includes means for inputting a request of a transmission data list, and means for outputting a list of the transmission data stored in the transmission data storing means when the request of the transmission data list is input.

11. The facsimile machine according to claim 1, wherein a character input box of the plurality of types of the templates stored in the template storing means is set common.

12. A facsimile transmission instruction device, comprising:
a transmission object selecting means for selecting by a user, a transmission object image from a transmission image file or transmitted transmission data;
a cover page selecting means for selecting by the user, a template of a cover page to be added to the transmission object image selected by the transmission object selecting means;
a character information inputting means for inputting by the user, character information into a character input box of the template selected by the cover page selecting means; and
an outputting means for outputting as data for transmission, the transmission object image selected by the transmission object selecting means, information that specifies the template selected by the cover page selecting means and the character information input by the character information inputting means by associating each to one another.

13. The facsimile transmission instruction device according to claim 12, wherein when the transmission data is selected as the transmission object image by the transmission object selecting means, at an initial state for the user to select the template of the cover page, the cover page selecting means changes a state of the template of the cover page added to the selected transmission data into an already selected state.

14. The facsimile transmission instruction device according to claim 13, wherein the cover page selecting means can change the template of the cover page to be added to the transmission object image from the template under the already selected state at the initial state to another template by the user.

15. The facsimile transmission instruction device according to claim 14, wherein the cover page selecting means includes a presenting means for presenting to the user at the initial state, templates of a plurality of types of cover pages including the already selected template, and the user can select one template from the plurality of types of the templates presented by the presenting means.

16. The facsimile transmission instruction device according to claim 12, wherein the character information inputting means can change the character information inserted in the template selected by the cover page selecting means by the user.

17. The facsimile transmission instruction device according to claim 12, wherein the transmission object selecting means can select a plurality of transmission object images from the transmission image file or the transmitted transmission data by the user.

18. The facsimile transmission instruction device according to claim 17, wherein the cover page selecting means includes a plurality presenting means for presenting to the user when a plurality of transmission data is selected as the transmission object image by the transmission object selecting means, templates of cover pages respectively added to the selected plurality of the transmission data, and the user can select one template from the plurality of the templates presented by the plurality presenting means.

19. The facsimile transmission instruction device according to claim 17, wherein the cover page selecting means includes a plurality presenting means for presenting to the user when a plurality of transmission data is selected as the transmission object image by the transmission object selecting means, templates of cover pages respectively added to the selected plurality of the transmission data and a template of a cover page that is different from the templates, and the user can select one template from the plurality of the templates presented by the plurality presenting means.

20. The facsimile transmission instruction device according to claim 12, wherein a character input box of a plurality of templates to be choices of the selection by the cover page selecting means is set common.

21. The facsimile transmission instruction device according to claim 12, wherein the transmission object selecting means includes a transmission data list presenting means for presenting to the user, a list of transmission data corresponding to a logged-in user ID, and the user can select one transmission data or a plurality of transmission data as the transmission object image from the transmission data presented by the transmission data list presenting means.

22. A facsimile transmission method, comprising the steps of:
a template storing step for storing templates of a plurality of types of cover pages in a template storing means;
a transmission data storing step for storing transmitted transmission data;
a transmission history storing step for storing in a transmission history storing means as a transmission history when a cover page is added at a transmission, template information that specifies a template of the added cover page and character information inserted in the added cover page by associating to each of the transmission data stored at the transmission data storing step;
a transmission data selecting step for selecting any one of the transmission data stored at the transmission data storing step;
a cover page creating step for changing one or both of the template information and the character information stored by being associated with the transmission data selected at the transmission data selecting step, and by using the changed template and the character information, inserting the character information into the template to create image information of a cover page; and
a transmitting step for transmitting transmission data having the image information of the cover page created at the creating step and transmission image information as one transmission object.

23. The facsimile transmission method according to claim 22, wherein at the transmitting step, the transmission data is transmitted by a facsimile communication.

24. The facsimile transmission method according to claim 22, wherein at the transmitting step, the transmission data is transmitted as an attached file of an electronic mail by an electronic mail communication.

25. The facsimile transmission method according to claim 22, wherein the cover page creating step further comprises the steps of:
a template specifying step for specifying, in accordance with template information stored in the transmission history storing means by being associated with the transmission data selected at the transmission data selecting step, a template of the cover page added to the selected transmission data;
a template changing step for changing the template specified at the template specifying step to any one of the templates stored in the template storing means; and
a step for inserting into the template changed at the template changing step, the character information stored in the transmission history storing means by being associated with the transmission data selected at the transmission data selecting step.

26. The facsimile transmission method according to claim 22, wherein the cover page creating step comprises the steps of:
a template specifying step for specifying, in accordance with the template information stored in the transmission history storing means by being associated with the transmission data selected at the transmission data selecting step, a template of the cover page added to the selected transmission data; and
a character information changing step for changing character information inserted in the template specified at the template specifying step.

27. The facsimile transmission method according to claim 22, wherein at the transmission data selecting step, a plurality of transmission data is selected, and
the cover page creating step comprises the steps of:
a template specifying step for specifying, in accordance with a plurality of the template information stored in the transmission history storing means by being associated with the plurality of the transmission data selected at the transmission data selecting step, templates of cover pages respectively added to the selected plurality of the transmission data; and
a template selecting step for selecting whether to reuse any one of the plurality of the templates specified at the template specifying step or whether to use a template among the templates stored in the template storing means that is different from the plurality of the templates specified at the template specifying step.
